(19) United States
(12) Patent Application Publication
(10) Pub. No.: US 2025/0283200 A1
(43) Pub. Date: Sep. 11, 2025

(54) Process for the production of a cemented carbide material having a reinforced binder phase

(71) Applicant: Betek GmbH & Co. KG, Aichhaden (DE)

(72) Inventors: Heiko Friederichs, Aichhalden (DE); Britta Philipp, Rottweil (DE); David Chmelik, Rottweil (DE); Michael Geiger, Aichhalden (DE); Ulrich Krämer, Wolfach (DE); Alexander Haller, Rottenburg (DE); Tobias Hilgert, Schramberg (DE)

(21) Appl. No.: 18/286,436

(22) PCT Filed: Apr. 21, 2022
(86) PCT No.: PCT/EP2022/060610

§ 371 Date: Oct. 11, 2023

(30) Foreign Application Priority Data
May 3, 2021 (DE) 10 2021 111 370.9
Aug. 4, 2021 (DE) 10 2021 120 273.6

(51) Int. Cl. C22C 29/08; B22F 3/10; B22F 9/04; B23B 27/14; C22C 19/07; C22C 29/00; C22C 29/02; C22C 29/06

(52) U.S. Cl. CPC C22C 29/08; B22F 3/1007; B22F 3/1021; B22F 9/04; B23B 27/148; C22C 19/07; C22C 29/005; C22C 29/02; C22C 29/067; B22F 2201/11; B22F 2201/20; B22F 2301/15; B22F 2302/10; B22F 2998/10; B22F 2999/00; B23B 2222/28

(57) ABSTRACT

The invention relates to a cemented carbide material, in particular hard metal, containing 70 to 95 wt %, preferably containing 80 to 95 wt %, tungsten carbide in dispersed form, and a binder phase, wherein the binder phase comprises metallic binder material, wherein the metallic binder material comprises Co, wherein the binder phase comprises intermetallic phase material and/or the dissolved elements Ni and Al, wherein the intermetallic phase material, if present, is formed according to the structural formula (M, Y)3 (Al, X), wherein M=Ni, Y═Co and/or another constituent and X=tungsten and/or another constituent, wherein the binder phase has the chemical element composition listed below: Ni>25 wt %, Al>4 wt %, the balance is made up of Co and dissolved binder constituents, for instance W and/or C. Such a cemented carbide material, is characterized by a high wear resistance and at the same time a high fracture strength.

The invention relates to a cemented carbide material, in particular a hard metal containing 70 to 95 wt % tungsten carbide in dispersed form, and a binder phase, wherein the binder phase comprises a metallic binder material, in particular Co.

EP 2 691 198 B1 describes such a cemented carbide material, namely a hard metal body, and a method for its production. According to this known process, a powder comprising coarse-grained tungsten carbide, a superstoichiometric proportion of carbon and cobalt powder is mixed. In addition, powdered tungsten was added to the powder. The tungsten powder and the cobalt powder had a mean particle size of approx. 1 μm. The coarse grain tungsten carbide had a mean particle size of 40.8 μm.

Then this powder was ground in a ball mill and hexane and paraffin wax were added. A green compact was pressed from this mixture and subsequently this green compact was sintered. After the sintering process, the obtained cemented carbide material was subjected to a heat treatment. It was heated to 600° C. and kept at this temperature for 10 hours.

After a subsequent cooling process, the cemented carbide material was analyzed. It turned out that there are nanoparticles in the binder phase of the cemented carbide material, wherein the nanoparticles have a size smaller than 10 nm. The nanoparticles were formed by the Eta phase (Co₃W₃C) or (Co₆W₆C) or the Theta phase (Co₂W₄C). The particle size of the nanoparticles was smaller than 10 nm.

It has been shown that nanoparticles are accompanied by an enhancement of the binder phase. This can increase the hardness of the cemented carbide material. A disadvantage of these materials is the lack of thermal stability of the nanoparticles. As a result, they are only suitable to a limited extent for high-temperature applications or for applications, in which a high temperature input occurs.

During rock machining and asphalt and concrete milling, friction generates very high temperatures on the tool surface. The hard material tungsten carbide has a high hot hardness at these temperatures and is not much affected by them. However, the strength of the metallic binder drops dramatically at these temperatures. The reduced strength of the metallic binder results in increased abrasive wear and or extrusion of the binder phase as a result of the stresses imposed by the application. As a result, the hard metal can no longer hold the tungsten carbide grains.

The invention addresses the problem of providing a cemented carbide material, in particular a hard metal, which has improved wear resistance and at the same time high fracture strength.

This problem is solved by the features of claim 1. Accordingly, a cemented carbide material, in particular hard metal, containing 70 to 95 wt %, preferably containing 80 to 95 wt %, tungsten carbide in dispersed form, and a binder phase, wherein the binder phase comprises metallic binder material, wherein the metallic binder material comprises Co, wherein the binder phase comprises intermetallic phase material and/or the dissolved elements Ni and Al, wherein the intermetallic phase material, if present, is formed according to the structural formula (M, Y)₃ (Al, X), wherein M=Ni, Y═Co and/or another constituent and X=tungsten and/or another constituent, wherein the binder phase has the chemical element composition listed below: Ni>25 wt %, Al>4 wt %, the balance is made up of Co and dissolved binder constituents, for instance W and/or C.

According to the invention, a cemented carbide material, in particular cemented carbide, is thus proposed, which either has a reinforced binder phase and/or is prepared to form a reinforced binder phase. In both cases the binder phase is reinforced by intermetallic phase material.

If the intermetallic phase material is present in the binder phase, it directly reinforces the latter.

If the dissolved elements Ni and Al are present in the binder phase in the cemented carbide, thermal treatment of the cemented carbide material forms intermetallic phase material, which then results in a reinforcement of the binder phase.

In so doing, during of thermal treatment the elements Ni, Co, W and Al from the binder phase combine to form the intermetallic phase material. This intermetallic phase material is formed according to the structural formula (M, Y)₃ (Al, X), wherein M=Ni, Y═Co and/or another constituent and X=tungsten and/or another constituent.

The thermal treatment of the cemented carbide material can be performed in different ways, which are suitable for forming the intermetallic phase material as intended.

In particular, this may be a thermal heat treatment, in particular an external heat input into the cemented carbide material. The thermal heat treatment can be effected, for instance, by an active source generating heating or cooling and in that this heating or cooling is introduced into or extracted from the material. For instance, the formation of the intermetallic phase material can be performed in a furnace, into which the cemented carbide material has been introduced. It is also conceivable that at least part of the surface of the cemented carbide material is acted upon by a heating device, for instance a burner.

Alternatively, it is conceivable that an excitation source is present that introduces energy into the cemented carbide material to generate heat therein. This can be, for instance, an induction coil or a laser device.

Alternatively, it is also conceivable that the heat is generated by passive heating, i.e., by using the cemented carbide material in an operating state, preferably as intended, or in the course of a method step in which the cemented carbide material is processed, in particular installed.

For instance, heat is generated in the cemented carbide material by friction, such as occurs during the intended use, in particular the intended application, in particular the application of tools, of the cemented carbide material. If it is a tool, it is moved relative to the object to be machined (for instance, in the case of a road milling pick, this road milling pick is moved relative to a road surface), frictional energy is generated, which results in heat generation in the cemented carbide material. The heat generated in this process can be used to achieve a self-reinforcing effect of the binder phase because of the, at least partial, formation of intermetallic phase material in the cemented carbide material.

It is also conceivable that the cemented carbide material is passively heated in the course of a method step, in which the cemented carbide material is applied to a holder, for instance to a tool base body or tool head. The heat generated can be used to form the intermetallic phase material. One conceivable joining process is a welding process, for instance a friction welding process, an electron beam welding process, a brazing and soldering process, for instance a brazing process, a furnace brazing process, an inductive brazing process, a diffusion brazing process, a plating process, for instance explosive plating.

In order to achieve the above effects, it is provided according to the invention that the binder phase has the chemical element composition listed below: Ni>25 wt %, Al>4 wt %, the balance is made up of Co and dissolved binder constituents, for instance W and/or C.

The intermetallic phase material forms a crystalline intercalation in the metallic binder.

This intermetallic phase material has significantly higher strength compared to the metallic binder material, in which it is intercalated, in particular at higher temperatures. At the surface of the cemented carbide material exposed to the wear attack, the intermetallic phase material reduces erosion or extrusion of the metallic binder material when it is used, for instance, in a ground engaging tool.

The motion of the ground engaging tool and the loosened ground material and the remaining ground material causes an abrasive and mechanical stress on the cemented carbide material. The tungsten carbide grains provide sufficient wear resistance to this wear attack. The problem in the state of the art is the binder material, which has a significantly lower strength than the tungsten carbide. Because the intermetallic phase material is now integrated or forms in the binder phase according to the invention, any rapid erosion or extrusion of the metallic binder material is prevented.

Moreover, surprisingly, the intermetallic phase material has also been shown to be able to reinforce the internal structure of the cemented carbide material. If strong impact stresses occur, the crystals of the intermetallic phase material reduce or prevent any sliding of the tungsten carbide particles in the region of the interconnecting binder phase and thus reduce or prevent any excessive plastic deformation of the binder phase. In particular, the individual crystals of the intermetallic phase material prop each other. This has a significant advantage, particularly at high tool temperatures, because at such temperatures the strength of the Co in the binder phase is reduced, but the intermetallic phase material still reliably provides sufficient support effect for the binder material.

Overall, it has been shown that a significant increase in the wear resistance of the cemented carbide material can be achieved based on the solution according to the invention. Tests have shown that, for instance, the use of the cemented carbide material according to the invention in the form of a pick tip of a round pick for road-milling machines results in an increase of wear resistance of up to 50%! It has been shown that such a significant increase in wear resistance can be achieved when milling road surfaces, both asphalt and concrete.

The cemented carbide material according to the invention can be used in particular to design the working areas of tools for working, loosening, conveying and processing plant-based or mineral materials or building materials, especially in the areas of agriculture or forestry or road construction, mining or tunnel construction.

If intermetallic phase material is present in the cemented carbide material, according to one variant of the invention provision may be made for the proportion of metallic binder material in the cemented carbide material to be 1 to 28 wt. %, preferably 1 to 19 wt %. In so doing, apart from unavoidable impurities, all or virtually all of this metallic binder material may be formed by Co. Such a choice of material results in a particularly tough binder phase, which can be effectively reinforced by the existing or the forming intermetallic phase material.

According to one embodiment of the invention, provision may be made for the sum of the elements Ni and Al in the cemented carbide material to be 1 to 28 wt %, preferably 1.5 to 19 wt %, at least in one segment of the cemented carbide body. These range specifications take into account Ni and Al both from any intermetallic phase material present and dissolved Ni or Al in the binder phase. Such compositions can be used to create in particular sophisticated hard-metal tools for ground engagement.

If no or only little intermetallic phase material is present in the cemented carbide material, according to a variant of the invention provision may be made for the proportion of binder phase in the cemented carbide material to be 5 to 30 wt %, preferably 5 to 20 wt %. In this case, most of the binder phase may be formed by the metallic binder material Co. In addition, Al and Ni may be dissolved as metallic binder material in the binder phase. Finally, other elements and unavoidable impurities may be present in the binder phase.

According to the invention, in addition to unavoidable impurities, provision may also be made for the binder phase to contain other constituents besides Co, in particular dissolved W, C, Ni, Al and/or Fe.

According to the invention, the intermetallic phase material optionally present in the binder phase is formed according to the structural formula (M, Y)₃ (Al, X), or the intermetallic phase material may be formed according to this structural formula, based on the elemental composition in the final cemented carbide material, wherein M=Ni, Y═Co and/or another constituent, and X=tungsten and/or another constituent.

If there is intermetallic phase material present in the binder phase, preferably at least for the majority of the crystals of the intermetallic phase material Y═Co and X═W. Accordingly, the composition of the dissolved constituents in the binder phase in the cemented carbide material is such that the intermetallic phase material can be formed by heat treatment or heat exposure in this way (see above).

Additionally, for some or all of the crystallites of the intermetallic phase material (Al, X) may be present such that X is present in the form of both W and Mo and/or Nb and/or

Ti and/or Ta and/or Cr and/or V. Accordingly, the composition of the dissolved constituents in the binder phase in the finished cemented carbide material can be selected to permit the intermetallic phase material to form due to heat treatment or heat exposure in this manner (see above).

According to the invention, provision may be made for the binder phase to comprise two or more intermetallic phase materials or only one intermetallic phase material and/or that the cemented carbide material is prepared such that thermal treatment or thermal exposure causes two or more intermetallic phase materials or only one intermetallic phase material to be formed.

According to a preferred embodiment of the invention, provision may be made for the binder phase to have the chemical element composition listed below:
Ni>35 wt %, Al>5 wt %, the balance is made up of Co and dissolved binder constituents, for instance W and/or C, particularly preferably Ni>40 wt %, Al>6.5 wt %, the balance is made up of Co and dissolved binder constituents, for instance W and/or C.

These figures refer to the total content of the individual substances in the binder phase. The data thus take into account the individual elements in dissolved form and additionally also the respective elements as they are bound in the intermetallic phase material.

It has been shown that an optimum reinforcing effect for the binder phase occurs at the specified values.

To be able to effect an optimum reinforcement of the binder phase using the intermetallic phase material, provision may be made in the context of the invention for the ratio of the mass fractions Al to Ni to be >0.10, preferably >0.12.

Preferably, provision may also be made in this context for the ratio of the mass fractions Al to Ni to be ≤0.46, preferably ≤0.18, more preferably ≤0.16.

The above data, which relate the ratio of mass fractions Al to Ni, take into account the total mass fraction, i.e., both the dissolved elements Al and Ni and Al and Ni in the intermetallic phase material (if present). Testing for the mass fractions of Al and Ni can be performed by means of a common ICP measurement.

One conceivable variant of the invention is such that the cemented carbide material has at least two volume segments, wherein the relative proportion of intermetallic phase material, based on a unit volume, is greater in the first volume segment than in the second volume segment. By designing at least two volume segments, it is possible to specifically influence the properties, in particular the tool properties, of the cemented carbide material. For instance, a zone subject to high abrasive wear may comprise the volume segment having a higher relative proportion of intermetallic phase material. In contrast, a zone that has to meet special toughness requirements can comprise the volume segment having a lower relative proportion of intermetallic phase material. For the sake of completeness, it should be noted at this point that the second volume segment, which has a lower relative proportion of intermetallic phase material compared to the first volume segment, that this second volume segment may also be without any intermetallic phase material.

A conceivable alternative invention is such that the first volume segment, which has the high relative proportion of intermetallic phase material, is delimited by at least one segment of the surface of the cemented carbide material. In this way, a high resistance to abrasion is achieved on the surface of the cemented carbide material there. Preferably, the second volume segment is not located adjacent to a surface of the cemented carbide material, but is located inside the cemented carbide material. Here, it provided high fracture stability.

Alternatively, provision may also be made for the second volume segment, which has a lower relative proportion of intermetallic phase material or no intermetallic phase material compared to the first volume segment, to be delimited by at least one segment of the surface of the cemented carbide material and preferably the first volume segment is not adjacent to a surface of the cemented carbide material. In this way, a tool that optimally adapts its cutting contour to the cutting task during tool application to achieve an optimum tool life can be created. In particular, it can be used to implement a so-called re-sharpening effect.

One conceivable variant of the invention is such that the binder phase, in particular the metallic binder material and/or the intermetallic phase material comprise Nb and/or Ti and/or Ta, and/or Mo and/or V and/or Cr, wherein preferably one or more of these materials is/are present dissolved in the binder phase and/or as carbides. In that way, an increase of the solvus temperature and the strength of the existing and/or the intermetallic phase formed by thermal action or treatment can be achieved. As a result, less intermetallic phase material is required while maintaining the strength of the cemented carbide material. Or the binder strength and thus the heat resistance increases due to the addition.

However, it is also conceivable that one or more of the aforementioned constituents is/are integrated into the crystal lattice of at least part of the intermetallic phase material or can be integrated into the crystal lattice of the intermetallic phase material by the thermal treatment (heat treatment or heat exposure). For instance, the titanium atom (or another material of the aforementioned group) primarily occupies the lattice site of Al or W in the crystal lattice of the intermetallic phase material and, like W, increases the precipitation temperature for the intermetallic phase material.

This means that, if present in the cemented carbide material, on the one hand, the intermetallic phase material can be precipitated more effectively during sintering, because precipitation starts at higher temperatures, and because the diffusion rate is significantly higher there.

On the other hand, this measure achieves a high heat resistance, since, as mentioned, the solvus temperature of the cemented carbide material is increased. In other words, the temperature required to redissolve the intermetallic phase material in the cemented carbide material increases.

According to the invention, provision may be made for the proportion of Mo and/or Nb and/or Ti and/or Ta and/or Cr and/or V in the binder phase to be ≤15 at %. In principle, the above-mentioned elements do form carbides. In the context of the invention, provision may now be made for the material composition to be chosen such that small amounts of these elements, according to the solubility product and their affinity to carbon, are dissolved in the binder phase, i.e., they can thus be incorporated into the crystal lattice of the intermetallic phase material and/or be dissolved in the metallic binder phase. If a cemented carbide material is desired that has high toughness of the binder phase, then the carbide fraction should be kept small. The sum of these materials present should then be a proportion ≤15 at %.

Furthermore, advantageously the powder mixture for the production of the cemented carbide material can be stoichiometrically set with regard to the carbon content, because the titanium (and/or Mo and/or Nb and/or Ti and/or Ta and/or Cr and/or V) takes over the role of the tungsten.

According to one design variant of the invention, provision may be made for the carbon content to be set stoichiometrically or sub-stoichiometrically. This measure prevents or minimizes graphite precipitation in the sintered material due to overstoichiometric carbon content. The inventors have recognized that such intercalations have a detrimental effect on the fracture strength of the cemented carbide material.

According to the invention, in particular provision may be made for the carbon content in the cemented carbide material to be in the range from:
C_{stoich} (wt %) −0.003 times the binder content (wt %) to C_{stoich} (wt %) −0.012 time the binder content wt %,
to be preferably in the range from:
C_{stoich} (wt %) −0.005 times the binder content (wt %) to C_{stoich} (wt %) −0.01 times the binder content wt %.

In the context of the invention, the advantageous effects described above are particularly pronounced in the case of coarse-grained hard metal. In a preferred embodiment of the invention, provision may therefore be made for the dispersed tungsten carbide to be present in the cemented carbide material as grains having a mean particle diameter, measured according to EN ISO 4499 Part 2, in the range from 1 to 15 μm, preferably in the range from 1.3 to 10 μm, particularly preferably in the range from 2.5 to 6 μm.

Preferably, provision is made for the maximum content of Fe in the binder phase to be 5% by weight and/or for other unavoidable impurities to be present in the binder material.

If provision is made for the existing intermetallic phase (M, Y)₃ (Al, X) or the intermetallic phase resulting from heat treatment or heat exposure to have a crystal structure L1₂ (space group 221) according present to ICSD (Inorganic Crystal Structure Database), then a microstructure in the binder phase results, in which the crystals of the intermetallic phase can effectively prop each other in the metallic binder material when the cemented carbide body is subjected to heavy loads.

Preferably, for the intended use, preferably of ground engaging tools, provision is made for the intermetallic phase material present or resulting from heat treatment or heat exposure to have a maximum size of 1500 nm, preferably a maximum size of 1000 nm.

According to a preferred embodiment of the invention, provision may be made for the cemented carbide material to be free or as free as possible from the Eta phase and/or Al₂O₃. The inventors have recognized that the maximum proportion of the Eta phase or the maximum proportion of Al₂O₃ should not exceed 0.6 vol % based on the total cemented carbide material. If both substances are present in the cemented carbide material, it is advantageous if the total of the Eta-phase material and of Al₂O₃ is at most 0.6 vol %.

The particle size of Al₂O₃ and/or of the Eta-phase material is advantageously at most 5 times the mean WC grain size, wherein the mean WC grain size and the particle size of Al₂O₃ and/or of the Eta phase material can be determined using the linear-intercept technique, according to EN ISO 4499 Part 2.

The toughness of the cemented carbide material can be negatively affected by the Eta phase or Al₂O₃. At higher Eta-phase contents, the cemented carbide material is only of limited suitability for use in demanding ground engaging tools. The same applies to Al₂O₃.

The above mentioned problem of the invention is also solved by a tool, in particular a comminution tool, a ground engaging tool, preferably for a road milling machine, a recycler, a stabilizer, an agricultural or silvicultural soil cultivation machine, having a base body, which comprises a working area, wherein at least one working element, consisting of a cemented carbide material, according to any of claims 1 to 17, is kept on the working area, preferably by means of a material bond, in particular a soldered or brazed joint, in particular a brazed joint.

Preferably, the cemented carbide material in the working area forms a cutting body having a cutting tip or a blade or a cutting edge or a working edge. It is also conceivable that the cemented carbide material is a hardfacing.

As was mentioned above, according to the invention provision may be made accordingly for the working element to be in the form of a cutting element, preferably having at least one cutting edge and/or at least one cutting tip, or in the form of a wear protection element, in particular a protective plate, a protective strip, a protective pin, a protective projection or a protective stud.

A particularly preferred application of the invention results when provision is made for the tool to be a cutting tool, a milling pick, in particular a road milling pick or mining milling pick, a plowshare, a cultivator tip, a drilling tool, in particular a soil auger, a crushing tool, for instance a crushing bit or a crushing bar, a mulching tool, a wood chipping tool or a shredding tool, a fractionation tool, for instance a screen.

A further particularly preferred application of the invention is such that the milling pick comprises a pick head and a pick shank connected directly or indirectly thereto, and that the working element is held on the pick head.

For instance, provision may also be made for the working element to be formed by the cemented carbide material according to the invention, wherein this working element forms a support for a superhard cutting tip consisting, for instance, of PCD material.

As described above, the cemented carbide material may be a hard metal having a reinforced binder phase. This reinforcement may occur by precipitation of intermetallic phase material during cooling in the sintering process and/or it is such that the intermetallic phase material is formed in a thermal process subsequent to the sintering process in which the cemented carbide material is brought to a temperature that allows precipitation of the intermetallic phase material in the cemented carbide material.

A nominal composition at the weighing of the raw materials of 70 to 95 wt % WC, 1 to 28 wt % metallic binder and 1 to 28 wt % intermetallic phase can be selected for the production of a hard metal according to. the invention. The metallic binder may have the elements Co, and optionally Fe and/or other constituents. The intermetallic phase at weighing is Nis Al.

The Problem of the invention is also solved using a method for creating a cemented carbide material, wherein first in a first process step a precursor cemented carbide material, in particular a hard metal, is created, containing 70 to 95 wt %, preferably 80 to 95 wt %, tungsten carbide in dispersed form, and a binder phase, wherein the binder phase comprises metallic binder material, wherein the metallic binder material comprises Co, wherein the binder phase comprises the dissolved elements Ni and Al, wherein the binder phase has the chemical element composition listed below:
Ni>25 wt %, Al>4 wt %, the balance is made up of Co and dissolved binder constituents, for instance W and/or C,
wherein in a further method step the precursor cemented carbide material is subjected to a heat treatment to form a cemented carbide material comprising intermetallic phase material in the binder phase, wherein the intermetallic phase material is formed at least in part according to the structural formula (M, Y)₃ (Al, X), wherein M=Ni, Y═Co and/or another constituent, and X=tungsten and/or another constituent.

The thermal treatment may comprise at least one heating step or at least one cooling step.

In accordance with the invention, provision may preferably be made for at least portion of the crystals of the intermetallic phase material (M, Y)₃ (Al, X) to have the crystal structure L12 (space group 221) in accordance with ICSD (Inorganic Crystal Structure Database) after heat treatment.

In order to be able to achieve a particularly effective reinforcement of the binder phase, in particular in the case of coarse grain hard metal as cemented carbide material, provision may advantageously be made for at least a portion of the intermetallic phase material to have a maximum size of 1500 nm, preferably a maximum size of 1000 nm (measured according to linear-intercept technique using a micrograph).

Advantageously, provision may be made for the coercivity H_{C}M of at least one segment, preferably of a segment, in which intermetallic phase material is present, of the cemented carbide material produced according to the method of the invention, to be:

$${H}_{c} M [ kA / m ] > ( 1.5 + {0.04}^{*} B ) + ( 12.5 - {0.5}^{*} B ) / D + 4 [ kA / m ] ,$$

$$preferably {H}_{c} M [ kA / m ] > ( 1.5 + {0.04}^{*} B ) + ( 12.5 - {0.5}^{*} B ) / D + 6 [ kA / m ] ,$$

$$particularly preferably {H}_{c} M [ kA / m ] > ( 1.5 + {0.04}^{*} B ) + ( 12.5 - {0.5}^{*} B ) / D + 10 [ kA / m ] ,$$

wherein B is the proportion of the binder phase in the cemented carbide material as wt % and
D is the particle size of the dispersed WC, determined by the linear-intercept technique according to EN ISO 4499 Part 2.

For common hard metals, with Co in the binder phase and without intermetallic phase material, coercivity is usually used to indirectly determine the mean grain size of the WC for a given binder content. According to the invention, the intermetallic phase material causes a significant increase in coercivity. Thus, the coercivity can be indirectly evaluated as a measure of the reinforcement of the binder phase due to the intercalated intermetallic phase material. The higher the coercivity, the greater the total interface between metallic binder material, intermetallic phase material and WC. A high degree of precipitated intermetallic phase material results in the individual crystals of the intermetallic phase material propping each other well in the binder phase, in particular at high temperatures (in particular at high tool temperatures).

Coercivity of at least one segment of the cemented carbide material H_{c}M [kA/m]>(1.5+0.04*B)+ (12.5−0.5*B)/D+4 [kA/m] can be used primarily for the above-mentioned wear protection applications, for instance for hardfacing.

Coercivity of at least one segment of the cemented carbide material, preferably H_{C}M [kA/m]>(1.5+0.04*B)+ (12.5−0.5*B)/D+6 [kA/m], can be used primarily for the above-mentioned demanding ground engaging tools.

Coercivities of at least one segment of the cemented carbide material preferably H_{C}M [kA/m]>(1.5+0.04*B)+ (12.5−0.5*B)/D+10 [kA/m] can be used primarily for the high-performance tools mentioned above.

According to one design variant of the invention, provision may also be made for the coercivity of at least one segment of the cemented carbide material to be 20% higher than the coercivity of a hard metal body having the same composition and WC grain size as the cemented carbide material, wherein the binder phase is formed solely of metallic Co binder; however, the hard metal body does not contain any intermetallic phase material.

A hard metal body having the same composition is thus a hard metal body, containing 70 to 95 wt % tungsten carbide in dispersed form, and a binder phase, wherein the binder phase comprises metallic binder material without intermetallic phase material, wherein the proportion of metallic binder material in the cemented carbide material is 5 to 30 wt % and apart from that the binder material has the same or approximately the same composition as the binder material of the cemented carbide material according to the invention.

As was mentioned above, the coercivity indirectly provides an indication of the proportion of intermetallic phase material in the binder phase. Thus, the coercivity indirectly indicates the degree of reinforcement of the binder phase.

In the context of the invention, the cemented carbide material may be such that the hot compressive strength of the cemented carbide material manufactured in accordance with the method of the invention at a temperature of 800° C. and a strain rate of 0.001 [1/s] is ≥1650 [MPa] and/or that the hot compressive strength of the cemented carbide material at a temperature of 800° C. and a strain rate of 0.01 [1/s] is ≥1600 [MPa] (measurement for a cylindrical specimen having diameter of 8 mm and height of 12 mm). For such a cemented carbide material it is possible to produce, in particular, cutting tips for road milling picks, in which the proportion of metallic binder material in the binder phase is 5 to 7 wt. % and the proportion of WC is in the range of 93 to 95 wt %, wherein preferably WC is present as coarse grains having a mean particle size in the range from 2 to 5 μm.

### Production (with Description of Measurement Methods)

### Production:

The production method by which a cemented carbide material containing intermetallic phase material in the binder phase can be produced via a powder metallurgy process routine is described below. The latter is divided into the process steps of producing a compressible powder mixture, shaping, and finally sintering it into compact and dense cemented carbide bodies.

WC powders of various particle sizes can be used as starting materials for the production of the powder mixture, in particular coarse-grained WC having a particle size FSSS>25 μm. Starting powders for the binder phase are extra-fine cobalt powder (FSSS 1.3 μm) and nickel-aluminum powder, for instance Ni-13Al powder with an aluminum content of approx. 13.3 wt %. The particle size of the Ni—Al powder is FSSS<70 μm, preferably FSSS<45 μm. W metal powder (FSSS<2 μm) and lamp black are used to set and adjust a targeted carbon content. For alloying the binder phase with alloying elements, such as Ti, Ta, Mo, Nb, V, Cr, their carbide powders, or their W-containing mixed carbides having particle sizes <3 μm are used.

The powder mixture is produced according to the state of the art by wet grinding, preferably in a ball mill equipped with hard metal balls. Ethanol and hexane are used as grinding media. Other possible grinding media would be acetone or aqueous media with suitable inhibitors.

In the production of powder mixtures for cemented carbide material having binder contents >15%, a single grinding process is sufficient due to the high binder content and favored recrystallization. For binder contents up to 15%, on the other hand, a multi-stage wet grinding process is advantageous in order to effectively comminute the Ni—Al powders and to minimize the formation of oxides during the grinding process.

In the first step, the Ni—Al powder is intensively mixed with grinding fluid and coarse-grained tungsten carbide having a mean particle size FSSS>20 μm, preferably from 30 to 60 μm. If necessary, pressing aids, small quantities of alloying constituents and cobalt powder can also be added at this stage.

The grinding parameters (duration, ratio of grinding balls to grinding stock, grinding medium) and the ratio of WC to Ni—Al powder are based on the WC grain size to be set in the cemented carbide material.

In the second step, 50 to 80 wt % WC raw material(s) of defined particle size(s) is/are added at this pre-grinding stage and blended, wherein the main focus is on reducing agglomerates and obtaining as homogeneous a mixture as possible.

If the alloy adjustment and the addition of pressing aids were not performed in the first grinding step (pre-grinding stage VM), it can now be done in the second step.

The slurry obtained during wet grinding is dried according to the state of the art and converted into a powder ready for pressing. Preferably, this is done using the process of spray drying.

Forming is preferably performed directly, by axial pressing using mechanical, hydraulic or electromechanical presses.

Sintering is performed between 135° and 1550° C. in a vacuum, preferably in industrial sintering HIP furnaces, in which an inert gas inlet creates overpressure after liquid phase sintering, wherein any residual porosity can be eliminated.

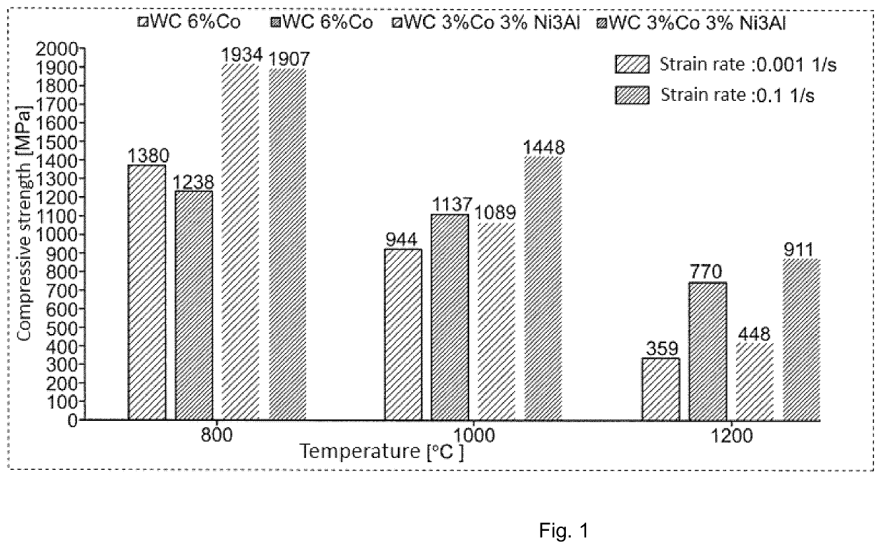

By way of example, FIG. 1 shows the WC—Co—Ni₃Al phase diagram for 3 wt % Co and 3 wt % Ni₃Al, which illustrates the formation of these precipitates.

After solidification of the melt, initially only WC and a solid solution of Co, Ni, AI, W and C are present. Only below the solvus temperature does the intermetallic phase material precipitate from this solid solution, wherein the intermetallic phase material is preferably formed according to the structural formula (M, Y)₃ (Al, X), wherein M=Ni, Y═Co and/or another constituent and X=tungsten and/or another constituent. A scanning electron microscope can be used to visualize these intermetallic phase materials.

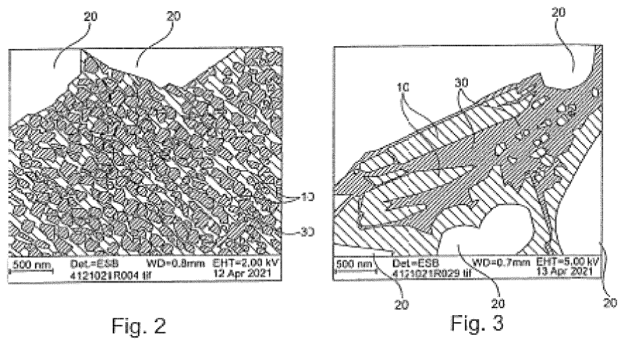

FIGS. 2 and 3 illustrate two different cemented carbide materials according to the invention, in the form of hard metals, using such scanning electron micrographs. The binder phase of such a hard metal can be clearly seen, in which the intermetallic phase material (lighter phase) 10 and the metallic binder material 30 (dark) can be identified. The WC grains 20 are bonded by the binder phase.

A uniform distribution of the intermetallic phase material in the binder phase is shown, wherein the crystals of the intermetallic phase material have a cubic shape and are preferably smaller than 1500 nm. The crystals of the intermetallic phase material (M, Y)₃ (Al, X) have a crystal structure L1₂ (space group 221) in accordance with ICSD (Inorganic Crystal Structure Database).

Such a cemented carbide material can be bonded to a steel base body to form a working element of a tool, for instance a comminution tool, ground engaging tool, preferably for a road milling machine, a recycler, a stabilizer, an agricultural or silvicultural soil cultivation machine. This working element is then disposed in the working area of the tool. The connection to the base body is made using a soldered or brazed joint, in particular a brazed joint. In this process, heat is introduced into the tool to create the soldered or brazed joint. The tool is then quenched, for instance in a water-oil emulsion.

During the soldering or brazing process, the intermetallic phase material at least partially dissolves again, such that constituents of the intermetallic phase material are present as dissolved constituents in the cemented carbide material after quench hardening. In this way, a precursor cemented carbide material is formed.

This precursor cemented carbide material is then subjected to thermal treatment, as described several times above. In this regard, heat may be introduced into the cemented carbide material via the thermal treatment, wherein the temperature is below the solvus temperature and preferably above 400° C. The treatment duration, i.e., the time in which the thermal treatment takes place, is in the range from 0.25 to 24 h. During thermal treatment, intermetallic phase material forms again, at least in portions of the cemented carbide material, to effect a reinforcement of the binder phase.

The thermal treatment can be an active process, in which heat is selectively introduced into the cemented carbide material by means of a heat source. Preferably, the heat treatment is performed passively, wherein, for instance during tool use, the precursor cemented carbide material comes into contact with the workpiece to be machined, for instance a road pavement. During this contact, heat is introduced into the precursor cemented carbide material, i.e., it is heated to a temperature at which the intermetallic phase material forms. In this way, the tool automatically reinforces itself according to the invention, wherein the cemented carbide material according to the invention is formed in the area subject to wear.

It is also conceivable that a cemented carbide material designed in the manner described above is manufactured in a sintering process, in which intermetallic phases are formed. Subsequently, this product can be brought to a temperature, preferably above the solvus temperature, at which the intermetallic phase material at least partially redissolves. Then this material is quenched to form the precursor cemented carbide material. Then the precursor cemented carbide material is subjected to heat treatment to form the cemented carbide material of the invention.

In order to be able to easily precipitate the intermetallic phase material in the binder phase, provision may preferably be made for the (M, Y)₃ (Al, X) content in the binder phase to be ≥40% and for the carbon balance to be set stoichiometrically or sub-stoichiometrically in that way.

It has been shown that a higher tungsten solution in the binder stabilizes the precipitation of the intermetallic phase material. This is caused by the incorporation of “Co3W” into the crystal structure of the intermetallic phase material and the shift of the precipitation range towards higher temperatures.

The elements Mo, Nb, Cr, V and in particular Ti, Ta, which can be added in small amounts (<15 at % in the binder) show a similar effect.

The usable alloy quantity depends on the individual solubility product of the metal carbides. Even though these appear negligible in terms of their magnitude, surprisingly clear effects are evident that cannot be attributed to a grain-reducing effect.

Due to the increased stability and better precipitation behavior, through the addition of further elements, the proportion of intermetallic phase material in the binder can be reduced and can also be lower than 40%. Furthermore, in the presence of, for instance, Ti or Ta, the carbon balance no longer needs to be set substoichiometrically because these elements take over the role of tungsten as stabilizer.

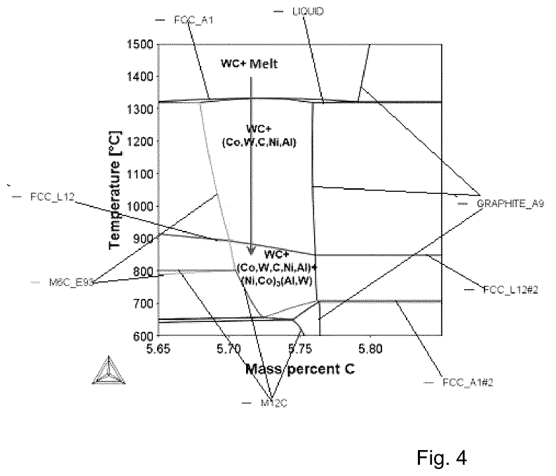

The effect of precipitation of the intermetallic phase material on high-temperature strength can be impressively demonstrated by hot compression tests. FIG. 4 shows the hot compressive strength of hard metals containing 6% binder each at different test temperature and strain rates. In particular, the intermetallic phase material increases the strength by approx. 40 to 50% at a test temperature of 800° C.

Physical quantities are determined on the cemented carbide material samples according to the invention, which contribute to characterize the material and its properties.

For hard metals, the determination of the coercivity H_{c}M and the specific magnetic saturation 4 ps have been established as non-destructive testing methods.

Both measured variables are also determined for the characterization of the cemented carbide material of the invention using a Koerzimat® 1.097 by Förster.

Another parameter for characterizing the material is density, which is determined by weighing according to Archimedes' principle.

The hardness of the material is determined in accordance with the standard applicable to hard metals on metallographically prepared polished specimens. Preferably, the Vickers HV10 hardness test with a test load of 10 kp is used (ISO 3878).

Also, the porosity of the sintered material (EN ISO 4499-4 standard) and aluminum oxide particles are detected and evaluated by light microscopy on polished specimens. To estimate the volume percentages of aluminum oxide in the microstructure, comparative images of A porosity and B porosity can be used, wherein A08 and B08 are approximately equal to a volume fraction of 0.6 vol %. The Eta phase is etched with Murakami solution according to the standard (EN ISO 4499-4) for a light microscopic examination. The average WC grain sizes are determined according to EN ISO 4499-2. In so doing, SEM (scanning electron microscope) images are evaluated using the linear-intercept technique.

The proportions of the intermetallic phase in the binder and the maximum size of the precipitated particles are also determined by SEM images, but using an inlense BSE detector. For this purpose, images are taken at several locations of the sample and the evaluation is performed on a representative section by means of image processing and determination of the area fractions by tonality demarcation.

### EXAMPLES

The table below shows examples of cemented carbide bodies according to the invention. The examples shown in this table can in principle be manufactured using the same method as described above:

| Example | Description |
|---|---|
| 1 | 6% binder, thereof approx. 50% intermetallic phase, raw materials without carbon |
| | correction |
| 2 | 6% binder, thereof approx. 50% intermetallic phase, addition of tungsten metal |
| | powder |
| 3 | 6% binder, thereof approx. 50% intermetallic phase, addition of carbon black |
| 4 | 6% binder, thereof approx. 40% intermetallic phase, raw materials without carbon |
| | correction |
| 5 | 6% binder, thereof approx. 50% intermetallic phase, addition of WTiC |
| 6 | 8.5% binder, thereof approx. 40% intermetallic phase, raw materials without carbon |
| | correction |
| 7 | 15% binder, thereof approx. 50% intermetallic phase, raw materials without carbon |
| | correction |
| 8 | Small series containing 6% binder, thereof approx. 50% intermetallic phase, addition |
| | of tungsten metal powder |
| 9 | Small series containing 6% binder, thereof approx. 50% intermetallic phase, without |
| | carbon correction |
| 10 | Small series containing 6% binder, thereof approx. 50% intermetallic phase, addition |
| | of carbon black |
| Reference, not according | 6% binder, cobalt only, grinding conditions similar to Examples 1 to 10 |
| to the invention | |

| | | | | 6-50 | 6-50 C− | 6-50 C+ | 6-40 |
|---|---|---|---|---|---|---|---|
| | Designation | | | Example 1 | Example 2 | Example 3 | Example 4 |
| Powder | Pre-grinding | Material | Size | [kg] | [kg] | [kg] | [kg] |
| preparation | Weighted sample | Ni—13Al | −325 | 0.120 | 0.120 | 0.120 | 0.096 |
| | | | mesh | | | | |
| | | Co | FSSS | 0.120 | 0.120 | 0.120 | 0.144 |
| | | | 1.3 μm | | | | |
| | | WC | FSSS | 0.760 | 0.760 | 0.760 | 0.760 |
| | | | 25 μm | | | | |
| | | WTiC 50:50 | FSSS | | | | |
| | | | 1.7 μm | | | | |
| | | Total | | 1 | 1 | 1 | 1 |
| | Grinding parameters | Grinding time | [h] | 24 | 24 | 24 | 24 |
| | | Ratio of | | 5:1 | 5:1 | 5:1 | 5:1 |
| | | grinding balls | | | | | |
| | | to grinding | | | | | |
| | | stock | | | | | |
| | Grinding result | Material | | [kg] | [kg] | [kg] | [kg] |
| | Weighted sample | Pre-grinding | | 0.25 | 0.25 | 0.25 | 0.25 |
| | | Co | FSSS | | | | |
| | | | 1.3 μm | | | | |
| | | WC | FSSS | 0.75 | 0.745 | 0.75 | 0.75 |
| | | | 25 μm | | | | |
| | | W-Metal | FSSS | | 0.005 | | |
| | | | 2 μm | | | | |
| | | Carbon black | | | | 0.0003 | |
| | | Total | | 1 | 1 | 1 | 1 |
| | Grinding parameters | Grinding time | [h] | 8 | 8 | 8 | 8 |
| | | Ratio of | | 5:1 | 5:1 | 5:1 | 5:1 |
| | | grinding balls | | | | | |
| | | to grinding | | | | | |
| | | stock | | | | | |
| Sintering | Parameter(s) | Sinter HIP Vacuum Furnace System: Vacuum solvent dewaxing, vacuum sintering/argon | | | | | |
| | | partial pressure, sintering temperature 1430° C. 1 h + 30′ high pressure 50 bar, | | | | | |
| | | pressurized cooling, cooling time in temperature interval 900-600° approx. 40 min | | | | | |
| physical | coercive force | H_{cM} | [kA/m] | 21.9 | 25.5 | 15.1 | 11.5 |
| characteristics | spec. magn. | 4πσ | [μTm³/kg] | 5.8 | 5.1 | 6.6 | 7.1 |
| | Saturation | | | | | | |
| | Hardness | HV10 | | 1200 | 1220 | 1170 | 1160 |
| | Density | ρ | [g/cm³] | 14.83 | 14.87 | 14.82 | 14.85 |
| | Porosity | EN ISO | | <A02, B00, | <A02, B00, | <A02, B00, | <A02, B00, |
| | | 4499-4 | | C00 | C00 | C00 | C00 |
| | Grain size WC | EN ISO | | 3 | 2.9 | 3.1 | 3.2 |
| | | 4499-2 | | | | | |
| | Hot compressive | | [MPa] | | | | |
| | strength* | | | | | | |
| Other | Eta phase | | | none | none | none | none |
| characteristic | Alumina | | | none | none | none | none |

| | | | | | | |
|---|---|---|---|---|---|---|
| [symbol] | Binder content in the hard metal | [m %] | 6 | 6 | 6 | 6 |
| | (weighted sample) | | | | | |
| | Proportion intermet. Phase of Binder ** | [%] | 46% | 48% | 39% | 35% |
| | max. size of the intermetallic phase | [nm] | <150 | <150 | <150 | <150 |

| | | | | 6-50 Ti | 8.5-40 | 15-50 | 6-50 C- S | 6-50 |
|---|---|---|---|---|---|---|---|---|
| | Designation | | | Example 5 | Example 6 | Example 7 | Example 8 | Example 9 |
| Powder | Pre-grinding | Material | Size | [kg] | [kg] | [kg] | [kg] | [kg] |
| preparation | Weighted sample | Ni—13Al | −325 | 0.120 | 0.240 | 0.240 | 9.000 | 9.000 |
| | | | mesh | | | | | |
| | | Co | FSSS | 0.120 | | | 9.000 | 9.000 |
| | | | 1.3 μm | | | | | |
| | | WC | FSSS | 0.740 | 0.760 | 0.760 | 57.000 | 57.000 |
| | | | 25 μm | | | | | |
| | | WTiC 50:50 | FSSS | 0.020 | | | | |
| | | | 1.7 μm | | | | | |
| | | Total | | 1 | 1 | 1 | 75 | 75 |
| | Grinding parameters | Grinding | [h] | 24 | 24 | 24 | 7 | 7 |
| | | time | | | | | | |
| | | Ratio of grinding balls | | 5:1 | 5:1 | 5:1 | 6.7:1 | 6.7:1 |
| | | to grinding stock | | | | | | |
| | Grinding result | Material | | [kg] | [kg] | [kg] | [kg] | [kg] |
| | Weighted sample | Pre-grinding | | 0.25 | 0.142 | 0.313 | 37.5 | 37.5 |
| | | Co | FSSS | | 0.051 | 0.075 | | |
| | | | 1.3 μm | | | | | |
| | | WC | FSSS | 0.75 | 0.807 | 0.612 | 111.7 | 112.5 |
| | | | 25 μm | | | | | |
| | | W-Metal | FSSS | | | | 0.8 | |
| | | | 2 μm | | | | | |
| | | Carbon | | | | | | |
| | | black | | | | | | |
| | | Total | | 1 | 1 | 1 | 150 | 150 |
| | Grinding parameters | Grinding | [h] | 8 | 8 | 8 | 6 | 7 |
| | | time | | | | | | |
| | | Ratio of grinding balls | | 5:1 | 5:1 | 5:1 | 3.3:1 | 3.3:1 |
| | | to grinding stock | | | | | | |
| Sintering | Parameter(s) | Sinter HIP Vacuum Furnace System: Vacuum solvent dewaxing, vacuum sintering/argon | | | | | | |
| | | partial pressure, sintering temperature 1430° C. 1 h + 30′ high pressure 50 bar, pressurized | | | | | | |
| | | cooling, cooling time in temperature interval 900-600° approx. 40 min | | | | | | |
| physical | coercive force | H_{cM} | [kA/m] | 25.3 | 11.7 | 20.4 | 28.7 | 18.5-21.8 |
| characteristics | spec. magn. | 4πσ | [μTm³/kg] | 5.4 | 10.0 | 13.9 | 4.9 | 4.6-4.9 |
| | Saturation | | | | | | | |
| | Hardness | HV10 | | 1205 | 1080 | 910 | 1250 | 1170 |
| | Density | ρ | [g/cm³] | 14.83 | 14.53 | 13.75 | 14.82 | 14.80 |
| | Porosity | EN ISO | | <A02, B00, | <A02, B00, | <A02, B00, | <A02, B00, | <A02, B00, |
| | | 4499-4 | | C00 | C00 | C00 | C00 | C00 |
| | Grain size WC | EN ISO | | 2.9 | 3 | 3.1 | 2.4 | 3.1 |
| | | 4499-2 | | | | | | |
| | Hot compressive | | [MPa] | | | | 1930 | |
| | strength* | | | | | | | |

| Other | Eta phase | | none | none | none | none | none |
|---|---|---|---|---|---|---|---|
| characteristic | Alumina | | none | none | <0.10 vol. % | <0.05 vol. % | <0.05 vol. % |
| [symbol] | Binder content in the hard metal | [m %] | 6 | 8.5 | 15 | 6 | 6 |
| | (weighted sample) | | | | | | |
| | Proportion intermet. Phase of | [%] | 49% | 35% | 47% | 52% | 42% |
| | Binder ** | | | | | | |
| | max. size of the intermetallic phase | [nm] | <150 | <150 | <150 | <100 | <100 |

| | | | | 6-50 C+ | 6-0 |
|---|---|---|---|---|---|
| | Designation | | | Example 10 | Reference |
| Powder | Pre-grinding | Material | Size | [kg] | [kg] |
| preparation | Weighted sample | Ni—13Al | −325 | 9.000 | |
| | | | mesh | | |
| | | Co | FSSS | 9.000 | 0.240 |
| | | | 1.3 μm | | |
| | | WC | FSSS | 57.000 | 0.760 |
| | | | 25 μm | | |
| | | WTiC 50:50 | FSSS | 0 | |
| | | | 1.7 μm | | |
| | | Total | | 75.000 | 1 |
| | Grinding parameters | Grinding | [h] | 7 | 24 |
| | | time | | | |
| | | Ratio of grinding balls | | 6.7:1 | 5:1 |
| | | to grinding stock | | | |
| | Grinding result | Material | | [kg] | [kg] |
| | Weighted sample | Pre-grinding | | 37.5 | 0.25 |
| | | Co | FSSS | | |
| | | | 1.3 μm | | |
| | | WC | FSSS | 112.5 | 0.75 |
| | | | 25 μm | | |
| | | W-Metal | FSSS | | |
| | | | 2 μm | | |
| | | Carbon | | 0.042 | |
| | | black | | | |
| | | Total | | 1 | 1 |
| | Grinding parameters | Grinding | [h] | 8 | 10 |
| | | time | | | |
| | | Ratio of grinding balls | | 3.3:1 | 5:1 |
| | | to grinding stock | | | |
| Sintering | Parameter(s) | Sinter HIP Vacuum Furnace System: Vacuum solvent dewaxing, vacuum | | | |
| | | sintering/argon partial pressure, sintering temperature 1430° C. 1 h + 30′ high | | | |
| | | pressure 50 bar, pressurized cooling, cooling time in temperature interval 900-600° | | | |
| | | approx. 40 min | | | |
| physical | coercive force | H_{cM} | [kA/m] | 16.9-18.9 | 5.2 |
| characteristics | spec. magn. | 4πσ | [μTm³/kg] | 4.7-4.9 | 11.5 |
| | Saturation | | | | |
| | Hardness | HV10 | | 1160 | 1150 |
| | Density | ρ | [g/cm³] | 14.83 | 14.76 |
| | Porosity | EN ISO | | <A02, B00, | <A02, B00, |
| | | 4499-4 | | C00 | C00 |
| | Grain size WC | EN ISO | | 2.9 | 3.1 |
| | | 4499-2 | | | |
| | Hot compressive | | [MPa] | | |
| | strength* | | | | |
| Other | Eta phase | | | none | |

| [symbol] | Alumina | | <0.05 vol. % | |
|---|---|---|---|---|
| | Binder content in the hard metal | [m %] | 6 | 6 |
| | (weighted sample) | | | |
| | Proportion intermet. Phase of | [%] | 49% | 39% |
| | Binder | | | |
| | max. size of the intermetallic phase | [nm] | <150 | <100 |

*non-standardized comparative test using specimens ø8 × 12 mm, test temperature 800° C., strain rate 0.001 1/s
** Evaluation of area proportions based on tonality demarcation in the micrograph. Calibration using solution-annealed samples isothermally aged at 700°/10 h of the same composition. [symbol]
indicates data missing or illegible when filed

According to the above, the invention thus relates to a cemented carbide material, in particular hard metal, containing 70 to 95 wt %, preferably containing 80 to 95 wt %, tungsten carbide in dispersed form, and a binder phase, wherein the binder phase comprises metallic binder material, wherein the metallic binder material comprises Co, dissolved Ni and dissolved Al, wherein the binder phase may optionally comprise intermetallic phase material, wherein the intermetallic phase material, if present, is formed according to the structural formula (M, Y)₃ (Al, X), wherein M=Ni, Y═Co and/or another constituent and X=tungsten and/or another constituent, wherein the binder phase has the chemical element composition listed below: Ni>25 wt %, Al>4 wt %, the balance is made up of Co and dissolved binder constituents, for instance W and/or C.

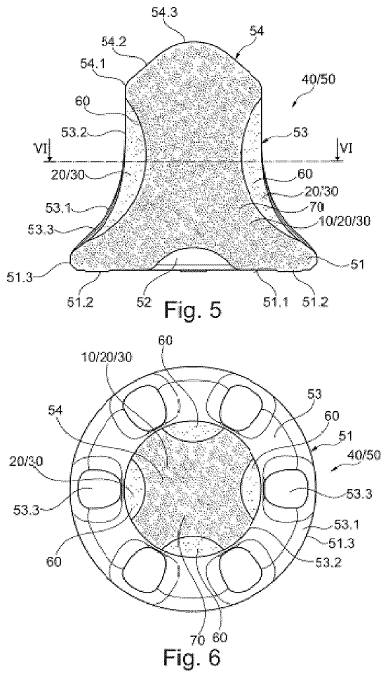

The invention is explained in greater detail below based on the exemplary embodiments shown in FIGS. 5 to 12. In the figures,

FIG. 5 shows a vertical section through a pick tip,

FIG. 6 shows the pick tip according to FIG. 5 along the course of the section line marked VI-VI in FIG. 5, and

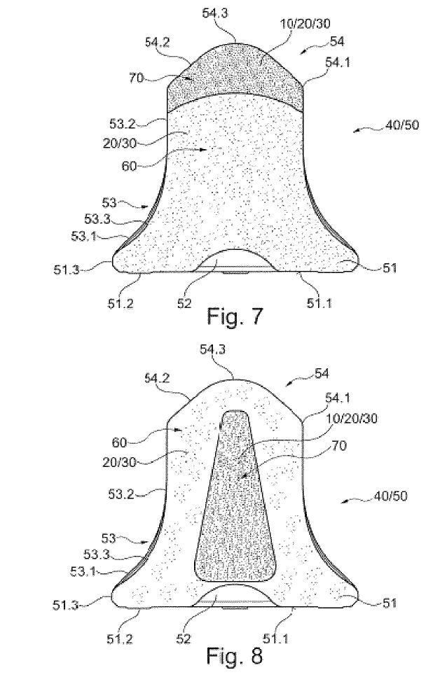

FIGS. 7 to 12 show a vertical section of the pick tip 50 of FIGS. 5 to 6, but with a modified microstructure composition.

FIGS. 5 to 12 show pick tips 50 in the form of a cemented carbide material 40. Advantageously, these milling picks 50 are for use at a cutting tool, in particular a cutting pick, a round pick, a road milling pick, a mining pick or the like.

The pick tip 50 is designed and prepared to be connected, preferably soldered or brazed, to a steel body. For this purpose, the steel body usually has a head to which a shank, preferably a round shank, is integrally formed. Facing away from the shank, the head has a mount for the pick tip 50. The pick tip 50 can be fastened in or to this mount.

The pick tip 50 is integrally designed and has a base part 51. The base part 51 can be used to connect the pick tip 50 to the steel body. Preferably, the base part 51 has a connection surface 51.1. For attaching the pick tip 50 to the steel body, the brazing material of a brazed joint may be disposed between the connection surface 51.1 and the steel body.

To maintain as constant a thickness as possible of the brazing gap between the pick tip 50 and the steel body, provision may be made for spacers 51.2 to be formed on the pick tip 50 in the area of the connection surface 51.1, which project beyond the connection surface 51.1 and are designed to rest on the steel body in such a way that the connection surface 51.1 is kept at a distance from a mating surface of the steel body for the soldering or brazing process.

Furthermore, provision may be made for one or more recesses 52 to be present in the area of the connection surface 51.1. In this case, the recess can preferably be such that it merges from the connection surface 51.1 via a convex fillet into a recessed section, which is advantageously designed as a concave trough. The recess 52 can be used to reduce the amount of material required for the pick tip 50. In addition, the recess 52 forms a reservoir for excess solder or brazing material in the area of the connection surface 51.1.

The base part 51 has a preferably circumferential edge 51.3, which can be formed as an at least sectionally convex formation, the edge 51.3 can be formed as a transition between the base part 51 and a transition section 53.

The transition section 53 has a first segment formed as a concave segment 53.1. Alternatively, a truncated cone-shaped geometry or a combination consisting of a concave segment 53.1 and an at least sectionally truncated cone-shaped geometry can also be provided. In the first segment, the pick tip 50 is tapered in the direction from the base part 51 toward a tip 54 of the pick tip 50.

Further, the transition section 53 may also include a cylindrical segment 53.2 that adjoins the first segment opposite from the base part 51. Preferably, the transition, at least in areas of the pick tip 50, between the first segment and the cylindrical segment is continuous, preferably continuously differentiable in the direction of the central longitudinal axis of the pick tip, such that jumps in continuity are avoided, as shown in FIG. 5.

The pick tip 50 can preferably have indentations 53.3 in the area of the transition section 53. They are used to reduce material and optimize the drainage of ground material that is removed during the application of tools.

The pick tip 50 has a tip 54 that adjoins the transition section 53, preferably the cylindrical segment 53.2. The connection section 54.1 can be designed as a convex curvature. A taper section 54.2, which merges into an end section 54.3 adjoins the connection section 54.1. The end section 54.3 is, preferably in the form of a convex curvature, particularly preferably in the form of a spherical cap.

FIG. 6 shows a cross-section and a top view of the pick tip 50. The indentations 53.3 are evenly distributed around the circumference of the pick tip 50 as can be clearly seen.

The pick tip 50 has least one first volume segment 70 and least one second volume segment 60.

In the second volume segment 60, the cemented carbide material 40 has tungsten carbide (WC) grains 20, which are bonded to each other via metallic binder material 30 of a binder phase. Provision may be made for no intermetallic phase material 10 or intermetallic phase material 10 preferably at a concentration of less than 30 wt %/unit volume, preferably less than 25 wt %/unit volume, particularly preferably less than 15 wt %/unit volume to be present in the second volume segment 60.

In the first volume segment 70, the cemented carbide material 40 comprises tungsten carbide (WC) grains 20 bonded via metallic binder material 30 of a binder phase. In the first volume segment 70, intermetallic phase material 10 is present, preferably at a concentration ≥30 wt %/unit volume, preferably in the range from 30 to 70 wt %/unit volume, particularly preferably in the range from 35 to 60 wt %/unit volume, further preferably in the range from 40 to 50 wt %/unit volume.

The intermetallic phase material is formed according to the structural formula (M, Y) 3 (Al, X), wherein M=Ni, Y═Co and/or another constituent and X=tungsten and/or another constituent. The binder phase has the chemical element composition listed below: Ni>25 wt %, Al>4 wt %, the balance is made up of Co and dissolved binder constituents, for instance W and/or C.

The relative proportion Y, in relation to a unit volume, of intermetallic phase material in the first volume segment 70 is greater than in the second volume segment 60.

As shown in the drawings, the first volume segment 70 and the second volume segment 60 may be delimited by at least a part of the surface of the cemented carbide material 40.

The first volume segment 70, which has the relatively higher proportion of intermetallic phase material 10, forms part of the surface of the pick tip 50, in particular at the tip 54 at the taper section 54.2 and/or at the end section 54.3.

Starting from the tip 54, the first volume segment 70 may further extend up to the base part 51. Preferably, the area of the base part 51 can also be formed by the second volume segment 60. The second volume segment 60 with the relatively lower content of intermetallic phase material 10 or without intermetallic phase material 10 is preferably disposed in the area of the transition section 53. As FIG. 6 illustrates, both the first volume segment 70 and the second volume segment 60 may be adjacent to the surface of the pick tip 50 in the area of the transition section 53.

The arrangement of the first and second volume segments 70, 60 according to the embodiment example shown in FIGS. 5 and 6 has the technical advantages listed below:

Because the first volume segment 70 forms the tip 54, a high abrasion resistance is provided here in the area that is particularly susceptible to wear.

In the non-wear area, this results in increased toughness and thus higher fracture stability.

Furthermore, it is conceivable that the volume segments can be used to set 60, 70 specific wear shapes, which, for instance, support re-sharpening of the pick tip.

FIGS. 7 to 12 show further design variants of a pick tip 50. To this end, the pick tip 50 is designed largely identically to the pick tip 50 of FIGS. 5 and 6. In this respect, to avoid repetition, reference is made to the above statements and only the differences are discussed. The pick tips 50 according to FIGS. 7 to 12 differ in particular in the arrangement and design of the first and second volume segments 70, 60.

As FIG. 7 illustrates, the first volume segment 70 is located in the area of the tip 54 and preferably partially in the cylindrical area 53.2 of the transition section 53. However, it is also conceivable that the first volume segment 70 is disposed only in the area of the tip 54. There, the first volume segment 70 effectively protects against abrasive wear in the area of the tip 54.

FIG. 8 illustrates that the first volume segment 70 may be located entirely or partially inside the pick tip 50. The first volume segment 70 can be designed in such a way that it preferably extends in the direction of the central longitudinal axis of the pick tip 50 across the entire area of the transition section 53. As mentioned above, the first volume segment 70 is characterized by a particularly high shear strength as a result of the presence of intermetallic phase material 10. In this way, the first volume segment 70 effectively reinforces the fracture-prone transition area 53.

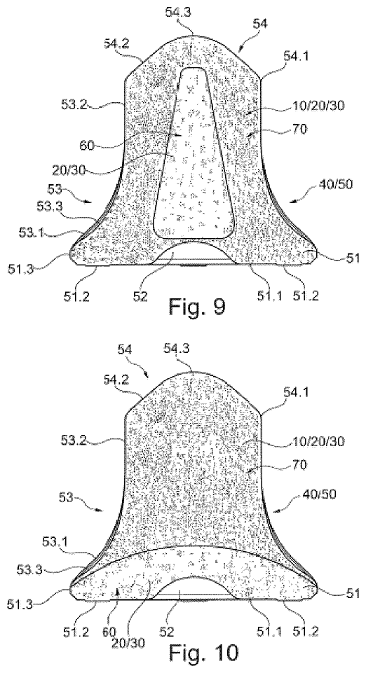

Conversely, as FIG. 9 shows, the second volume segment 60 may be located wholly or partially inside the pick tip 50. The first volume segment 70 then preferably completely encompasses the second volume segment 60. The first volume segment completely or almost completely forms the surface of the pick tip 50, to protect this tip in particular effectively against abrasion and to prevent the pick tip 50 from breaking in the area of the transition section 53. Owing to the large extension transverse to the central longitudinal axis of the pick tip 50, the first volume segment 70 also has a high equatorial modulus of resistance against bending.

FIG. 10 illustrates that, in further development of the variant of FIG. 7, the first volume segment 70 with its relatively high proportion of intermetallic phase material 10 can extend across the area of the tip 54 and the transition section 53, such that it preferably completely forms the surface of the tip 54 and the transition section. The first volume segment 70 is extended up to the base part 51 or is also extended into the base part 51, as illustrated in FIG. 10.

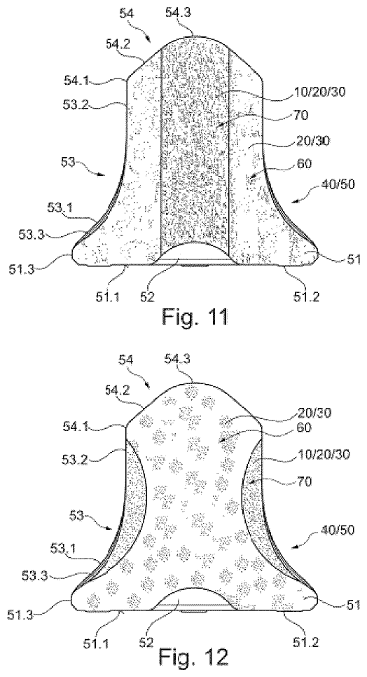

FIG. 11 shows that the first volume segment 70 may also extend inside the pick tip 50 to form a continuous volume segment, from the end section 54 3 of the tip 54 to the base part 51.

FIG. 12 illustrates that, in reversal to the embodiment example according to FIGS. 5 and 6, provision may also be made for the first and second volume segments 70, 60 to be interchanged.

The above drawings shall thus be understood to denote schematic representations. In particular, the first and second volume segments 70, 60 do not form exactly sharply defined areas as shown in the drawings, but rather transition sections form between the two volume segments 70, 60.

For the production or formation of the cemented carbide materials 40 shown in FIGS. 5 to 12, a method is used according to the invention, wherein first in a first process step a precursor cemented carbide material, in particular a hard metal, is created, which contains 70 to 95 wt %, preferably 80 to 95 wt %, tungsten carbide in dispersed form, and a binder phase. The binder phase has at least Co as the metallic binder material and the dissolved elements Ni and Al. The binder phase has the chemical element composition listed below:

Ni>25 wt %, Al>4 wt %, the balance is made up of Co and dissolved binder constituents, for instance W and/or C.

In a further process step, the precursor cemented carbide material is subjected to heat treatment as explained above to form the cemented carbide material 40, which has intermetallic phase material 10 in the binder phase at least in the first volume segment 70. The intermetallic phase material 10 is formed according to the structural formula (M, Y)₃ (Al, X), wherein M=Ni, Y═Co and/or another constituent and X=tungsten and/or another constituent.

To this end, in the further process step, the precursor cemented carbide material may be maintained in a temperature range between 400° C. and the solvus temperature during heat treatment for a time period ranging from 0.25 to 24 hours. For the targeted formation of the individual volume segments 60, 70, for instance, targeted heating can be performed by means of a laser or an induction coil.

1-27. (canceled)

28. A cemented carbide material, comprising:
tungsten carbide in an amount ranging from 70 wt % to 95 wt %;
a binder phase comprising a metallic binder material, the metallic binder material comprising nickel in an amount greater than 25 wt % of the metallic binder material, aluminum in an amount greater than 4 wt % of the metallic binder material, and cobalt.

29. The cemented carbide material of claim 28, wherein the binder phase comprises an intermetallic phase material having a structural formula of (M, Y)₃ (Al, X), wherein M is nickel, Y comprises cobalt and X comprises tungsten.

30. The cemented carbide material of claim 29, wherein at least a portion of the intermetallic phase material has an L1₂ crystal structure.

31. the cemented carbide material of claim 29, wherein Y further comprises Nb, Ti, Ta, Mo, V, Cr, or a combination thereof, and wherein X further comprises Nb, Ti, Ta, Mo, V, Cr, or a combination thereof.

32. The cemented carbide material of claim 28, wherein the binder phase further comprises dissolved nickel and dissolved aluminum.

33. The cemented carbide material of claim 28, wherein the binder phase further comprises dissolved tungsten, carbon, or a combination thereof.

34. The cemented carbide material of claim 28, wherein a ratio of a mass fraction of aluminum in the cemented carbide material to a mass fraction of the nickel in the cemented carbide material is greater than 0.1.

35. The cemented carbide material of claim 28, wherein the cobalt is present in in an amount ranging from 1 wt % to 28 wt % of the cemented carbide material.

36. A component fabricated from the cemented carbide material of claim 29, comprising:
a first volume segment;
a second volume segment; and
a pick tip comprising a surface;
wherein a relative proportion of the intermetallic phase material, in volume percent, is greater in the first volume segment than in the second volume segment, or wherein a relative proportion of the intermetallic phase material, in volume percent, is greater in the second volume segment than in the first volume segment.

37. The component of claim 36, wherein a sum of the nickel in the cemented carbide material and the aluminum in the cemented carbide material ranges from 1 wt % to 28 wt % of at least one of the first volume segment and the second volume segment.

38. The component of claim 36, wherein the first volume segment is delimited by at least a portion of the surface of the pick tip of the component, and the second volume segment is not adjacent to the surface of the pick tip of the component.

39. The component of claim 36, wherein the second volume segment is delimited by at least a portion of the surface of the pick tip of the component, and the first volume segment is not adjacent to the surface of the pick tip of the component.

40. The cemented carbide material of claim 36, wherein a coercivity (H_{c}M) of at least one of the first volume segment and the second volume segment of the component is greater than (1.5+0.04*B)+(12.5−0.5*B)/D+4 kA/m, wherein B is a proportion of the binder phase in the cemented carbide material, in wt %, and D is a particle size of the tungsten carbide in the component.

41. The cemented carbide material of claim 28, wherein a carbon content of the cemented carbide material is stoichiometric or substoichiometric, and ranges from C_{stoich} (wt %) −0.003*binder content (wt %) to C_{stoich} (wt %) −0.012*binder content wt %.

42. The cemented carbide material of claim 28, wherein the binder phase contains 15 at % or less combined Nb, Ti, Ta, Mo, V, and Cr content.

43. The cemented carbide material of claim 28, wherein the tungsten carbide is present in the cemented carbide material as grains having a mean particle diameter ranging from 1 μm to 15 μm.

44. The cemented carbide material of claim 28, wherein the binder phase comprises less than 5 wt % Fe.

45. The cemented carbide material of claim 29, wherein the intermetallic phase material is present in the cemented carbide material in particles having a maximum size of 1500 nm.

46. The cemented carbide material of claim 28, further comprising an Eta phase, an Al₂O₃ phase, or a combination thereof, wherein a combined content of the Eta phase and Al₂O₃ phase of the cemented carbide material is 0.6 vol % or less of the cemented carbide material.

47. The cemented carbide material of claim 46, wherein an average particle size of the Eta phase and the Al₂O₃ phase is no greater than 5 times an average particle size of the tungsten carbide.

48. A tool comprising:
a base body having a working area; and
a working element attached to the working area;
wherein the working element comprises the cemented carbide material of claim 28, and is attached to the working element by a material bond.

49. The tool of claim 48, wherein the tool is a comminution tool or a ground engaging tool for a road milling machine, a recycler, a stabilizer, or an agricultural or silvicultural soil cultivation machine.

50. The tool of claim 48, wherein the working element is a cutting element having at least one cutting edge or at least one cutting tip, or a wear protection element.

51. The tool of claim 48, wherein the tool is a cutting tool, a milling pick, a road milling pick, a mining milling pick, a plowshare, a cultivator tip, a drilling tool, a soil auger, a crushing tool, a mulching tool, a wood chipping tool, a shredding tool, or a fractionation tool.

52. The tool of claim 51, wherein the tool is a milling pick and comprises a pick head, a pick shank connected to the pick head, and wherein the working element is held at the pick head.

53. A method for producing a cemented carbide material, comprising:
creating a precursor cemented carbide material comprising tungsten carbide in an amount ranging from 70 wt % to 95 wt % and a binder phase; and
subjecting the precursor cemented carbide material to a heat treatment to form a cemented carbide material having an intermetallic phase material dispersed in the binder phase;
wherein the binder phase comprises a metallic binder material, dissolved nickel, and dissolved aluminum, and further comprises more than 25 wt % nickel, more than 4 wt % aluminum, and cobalt,
wherein the metallic binder material comprises cobalt,
wherein the intermetallic phase material has a structural formula of (M, Y)₃ (Al, X), wherein M is Ni, Y comprises cobalt, and X comprises tungsten.

54. The method of claim 53, wherein the binder phase further comprises tungsten, carbon, or a combination thereof in a dissolved state.

55. The method of claim 53, wherein the intermetallic phase material has an L1₂ crystal structure and a maximum particle size of 1500 nm.

56. The method of claim 53, wherein the precursor cemented carbide material is maintained at a temperature ranging from 400° C. to a solvus temperature of the precursor cemented carbide material during the heat treatment, for a period of time ranging from 0.25 hours to 24 hours.
